(19) United States
(12) Patent Application Publication
(10) Pub. No.: US 2024/0236716 A1
(43) Pub. Date: Jul. 11, 2024

(54) ARRANGEMENT AND METHOD FOR OPERATING A NETWORK INFRASTRUCTURE, METHOD FOR OPERATING A GATEWAY, GATEWAY, SHARED-USAGE TERTIARY INFRASTRUCTURE AND METHOD FOR APPLYING A PROGRAM LOGIC OF GATEWAY SOFTWARE

(71) Applicant: Diehl Metering Systems GmbH, Nürnberg (DE)

(72) Inventors: Charles Fendt, Stein (DE); Achim Schmidt, Weissenohe (DE)

(21) Appl. No.: 18/615,331

(22) Filed: Mar. 25, 2024

Related U.S. Application Data
(63) Continuation of application No. PCT/EP2022/074656, filed on Sep. 5, 2022.

(30) Foreign Application Priority Data
Sep. 27, 2021 (DE) 10 2021 124 959.7

(51) Int. Cl. H04W 24/02

(52) U.S. Cl. CPC H04W 24/02

(57) ABSTRACT

An arrangement of a network infrastructure includes at least one network node, in particular a sensor, a consumption meter and/or an end device, and a gateway having at least one transceiver. The network node communicates with the gateway over a primary communication path. The transceiver is configured to communicate by transmission technology used by the network node. The gateway communicates with at least one head end system over tertiary communication paths. A shared-usage tertiary infrastructure is intended for the tertiary communication paths. The tertiary infrastructure is intended to provide central network services. The shared-usage tertiary infrastructure provides specific network services for the transmission technologies in the primary communication path. A method for operating a network infrastructure, a method for operating a gateway, a gateway, a shared-usage tertiary infrastructure, and a method for applying the program logic of the gateway software, are also provided.

### CROSS-REFERENCE TO RELATED APPLICATION

This application is a continuation, under 35 U.S.C. § 120, of copending International Patent Application PCT/EP2022/074656, filed Sep. 5, 2022, which designated the United States; this application also claims the priority, under 35 U.S.C. § 119, of German Patent Application DE 10 2021 124 959.7, filed Sep. 27, 2021; the prior applications are herewith incorporated by reference in their entirety.

### FIELD AND BACKGROUND OF THE INVENTION

The present invention relates to an arrangement of a network infrastructure, including at least one network node, in particular a sensor, a consumption meter and/or an end device, a gateway having at least one transceiver, the at least one network node communicating with the gateway over a primary communication path, the at least one transceiver configured to communicate by transmission technology used by the at least one network node, and at least one head-end system, the gateway communicating with the at least one head end system over tertiary communication paths. The invention also relates to a method for operating a network infrastructure, including at least one network node, a gateway and at least one head-end system. The invention further relates to a gateway for communicating over primary communication paths and for communicating over tertiary communication paths, including at least one transceiver. The invention additionally relates to a shared-usage tertiary infrastructure for communicating over tertiary communication paths with at least one head-end system and with a gateway. The present invention concomitantly relates to a method for applying program logic of the gateway software.

Data transmission from measuring units such as sensors, consumption meters or components of smart home controllers is becoming increasingly important in everyday use. An important area of use for measuring units is the deployment of smart consumption-data acquisition devices, also known as smart meters. Those are typically consumption meters, e.g. for energy, electricity, gas or water, that are integrated in a supply network, indicate to the particular utility customer the actual consumption, and use a communication network to transmit the consumption data to the supplier. The advantage of smart consumption meters is that there is no need to take meter readings manually, and the supplier can invoice more quickly on the basis of actual consumption.

Consumption-data acquisition devices of the type in question transmit the accrued measurement data usually in the form of data packets or data messages by radio, for example in the SRD (Short Range Device) or ISM (Industrial, Scientific, Medical) frequency band, to higher-level data collectors (e.g. concentrators, network node points or control centers of a supplier). There are two crucial issues associated with smart consumption-data acquisition devices: energy consumption, because those devices are usually battery-powered and are meant to have the longest possible maintenance intervals, and operational reliability.

Smart measurement infrastructures are being used increasingly for acquiring the consumption data. In those measurement infrastructures (consumption-data acquisition systems), the consumption meters constitute the network nodes or the end devices which record measurement data at the consumption points. The measurement data is transmitted digitally from the consumption meters to a higher level management system or head end system. The head-end system manages the consumption data and communicates with the consumption meters. A smart measurement infrastructure can include a large number of consumption meters. Therefore, a simultaneous direct communication-connection from all of the consumption meters to the head-end system is often not possible because there are insufficient communication measures available or the transmission bandwidths are too small. In order to ensure nonetheless that the data acquired and sent by the consumption meters can be transmitted to the head-end system as reliably as possible with minimum possible losses, gateways are deployed as data collection facilities known as data collectors. The gateways are disposed in the communication route between the consumption meters and the head-end system. They collect on a communication path the consumption data sent by the consumption meters, and act as buffer memories until the head-end system retrieves the consumption data that they are storing. The data collectors can also perform additional tasks, for instance tasks such as querying the status of consumption meters and providing that information and program codes, for instance firmware updates and software updates and communication time schedules.

Communication paths between gateways and network nodes, for instance consumption meters, are normally referred to as primary communication, whereas communication paths between gateway and the head-end system are referred to as tertiary communication. For the primary communication from a network node to a gateway, other transmission paths than for the tertiary communication from a gateway to the head-end system are normally used, because there are different requirements placed on, for example, the transmission bandwidth, the energy consumption, the transmission quality, the range and the redundancy of the systems.

Setting up a new transmission technology in already installed network nodes that have a competing link presents a challenge, which is a problem. Hence there is the need for a competitive migration scenario in which a new transmission technology can be used in parallel with already installed network nodes. Any transmission technology from the low-power wide area network (LPWAN) class can advantageously be installed or provided as the transmission technology for already installed and/or new network nodes.

That problem has previously been solved by the operator having to set up an additional parallel infrastructure, which means that an additional new gateway supporting the new transmission technology must be set up for each existing gateway. That means that the operator faces additional costs and charges, for instance for a mast site or an LTE contract. Additional expenditure is needed for the installation and maintenance. In addition, negative effects can arise for the communication connections because the connections of the two gateways interfere with one another. Hence, for instance, it is necessary to install at each site of an antenna an “IZAR RDC-Premium” from Diehl Metering for a wireless M-bus connection, a LoRaWAN base station, a “MIOTY Premium Gateway” for MIOTY. For the tertiary communication it may be necessary to install an LTE router, for example.

### DESCRIPTION OF THE RELATED ART

U.S. Publication No. 2013/0275736 A1 describes a consumption-meter infrastructure formed of a head-end, data collector and consumption meter, with the data collector receiving data from each consumption meter, which it stores and sends periodically to a central location.

European Patent EP 2 671 052 B1 discloses a utility meter for metering at least one utility consumption and for optimizing data traffic of messages exchanged with a multiplicity of remote utility supply centers.

U.S. Publication No. 2014/0361906 A1 discloses a method for communicating by using a tag, which method includes receiving sensor data from at least one sensor, generating sensor data, and transmitting sensor data.

### SUMMARY OF THE INVENTION

It is accordingly an object of the invention to provide an arrangement and a method for operating a network infrastructure, a method for operating a gateway, a gateway, a shared-usage tertiary infrastructure and a method for applying a program logic of gateway software, which overcome the hereinafore-mentioned disadvantages of the heretofore-known arrangements and methods of this general type and which allow increased operating flexibility with greater interoperability in parallel with advantageous cost efficiency.

With the foregoing and other objects in view there is provided, in accordance with the invention, an arrangement of a network infrastructure that comprises at least one network node, in particular a sensor, a consumption meter and/or an end device, a gateway having at least one transceiver, the at least one network node communicating with the gateway over a primary communication path, the at least one transceiver configured to communicate by the transmission technology used by the at least one network node, at least one head-end system, the gateway communicating with the at least one head end system over tertiary communication paths, a shared-usage tertiary infrastructure intended for the tertiary communication paths, the tertiary infrastructure intended to provide central network services, and the shared-usage tertiary infrastructure providing specific network services for the used transmission technologies in the primary communication path.

The approach known in the prior art for integrating Internet-of-Things (IoT) technology into consumption meters makes it straightforward to provide consumption meters in existing networks, which is advantageous for existing or public networks. If, however, it is intended to operate a proprietary infrastructure, this requires selecting a specific network technology. The present invention advantageously offers more flexibility, because a plurality of different links can be operated in parallel. These links do not necessarily have to be installed at the same time, allowing them to be set up over a prolonged time period. To this end, the existing functionalities of the network technologies and transmission technologies are split between the gateway and a backhaul in order to continue to facilitate all existing usage cases. The gateway performs here abstraction of the individual connections in the uplink and also individual procedures for the transmission technologies for connections in the downlink. In addition, it forms an interface to the individual specific network services in the backhaul in order to make functionalities specific to the transmission technologies available in the network. The usual infrastructure for transmission connects each specific network service of the different transmission technologies to a standardized interface for the head-end system in order to facilitate convenient integration of the network.

A plurality of different transmission technologies in the form of hardware and software are integrated on the basis of a flexible gateway platform. The hardware of the gateway integrates different transceivers, and the software package allows it to process different transmission protocols. The different transmission protocols include network key management for LoRaWAN and MIOTY, processing the data transfer rate (baud rate) for wired M-bus connections, processing different addressings, for instance IEEE EUI64 or M-bus addresses (primary and secondary), and timing for bidirectional transmissions with the network nodes, in particular with consumption meters. A supporting shared-usage tertiary infrastructure is installed in order to facilitate central network services. The network services can include, for example, device integration in accordance with the definitions in a standard and providing keys for the network, for instance in the form of a LoRaWAN join server and MIOTY service center.

It is particularly advantageous that the infrastructure no longer determines the conditions for compatibility of the network nodes but instead ensures compatibility with all network nodes. Hence the transmission technology is defined by the network node or can be selected so as to optimize the network. A gateway can connect a plurality of network nodes that use different transmission technologies. This is cost-effective and allows the most suitable transmission technology to be selected. This can achieve better radio properties compared with operating a plurality of gateways in parallel. A gateway can combine the data from a network node that the gateway has received via different transmission technologies. For example, a network node in the form of a consumption meter can be connected to the gateway simultaneously by wireless M-bus and LoRaWAN. Employing a single gateway allows the transmit process to be planned across transmission technologies, thereby ensuring optimized utilization of the physical transport layer, in particular in terms of time and frequency, across all transmission technologies. The unified integration via a shared-usage infrastructure allows straightforward first-time integration and inexpensive subsequent integration of additional transmission technologies.

The gateway can advantageously include software for handling the transmission technology used by the at least one network node. This is a simple way of ensuring that the transmitted data from the network node can be received and processed further. Using software also means that additional transmission technologies can be implemented easily at a later date.

The at least one network node can advantageously use as the transmission technology a technology from the low-power wide area network (LPWAN) class, and the specific network services of the tertiary infrastructure provide accordingly specific network services of the LPWAN protocols.

The at least one network node can expediently use as the transmission technology a technology from the group consisting of the LoRaWAN transmission technology, the MIOTY transmission technology and the wireless M-bus transmission technology, and the specific network services of the tertiary infrastructure provide accordingly specific LoRaWAN network services, specific MIOTY network services and/or wireless M-bus network services.

It is also possible that at least two network nodes are included, wherein the gateway has at least two transceivers, the first transceiver being configured to communicate by the transmission technology used by the first network node, and the second transceiver being configured to communicate by the transmission technology used by the second network node, wherein the shared-usage tertiary infrastructure provides first specific network services for the first transmission technology, and second specific network services for the second transmission technology.

The transmission technologies in the primary communication path can expediently include wired technologies and non-wired technologies by using radio transmission. It is hence possible, for example, to be able to use the M-bus as a wired or wireless transmission technology.

The gateway can advantageously have at least two transceivers, wherein at least one network node is included that has at least two transmission technologies, so that the at least one network node communicates with the first transceiver via a first transmission technology, and with the second transceiver via a second transmission technology, wherein the shared-usage tertiary infrastructure provides the at least one network node with first specific network services for the first transmission technology, and second specific network services for the second transmission technology.

With the objects of the invention in view, there is also provided a method for operating a network infrastructure, in particular according to the invention, comprising at least one network node, a gateway, at least one head-end system, and a shared-usage tertiary infrastructure, so that the gateway receives data messages from at least one network node, checks the identity of the sender, determines the data type, and transmits the data to the intended head-end system.

The gateway can expediently additionally collect the incoming data selectively, detect the connection properties, and perform data operations, in particular data reduction and data sorting, with the transmission to the intended head-end system being carried out in accordance with stipulated data guidelines.

The shared-usage tertiary infrastructure can advantageously arbitrate the transmission between the linked network devices and network services, so that data transmissions can be routed from senders to intended recipients, with mutual trust being warranted, in particular by the use of certificates.

It is advantageously possible that the shared-usage tertiary infrastructure performs specific network services for the transmission technologies used. These specific network services can include device integration and/or providing keys for the network.

It is particularly expedient that the tertiary communication paths are guaranteed via a shared-usage tertiary infrastructure, with the tertiary infrastructure being intended to provide central network services, in particular a LoRa join server or MIOTY service center, preferably for the integration defined in a standard or for key allocation procedures. Hence shared access is advantageously possible in the tertiary communication path to the functions of the network nodes linked via primary communication paths.

With the objects of the invention in view, there is furthermore provided a method for operating a gateway according to the invention, comprising providing gateway software with a three-level hierarchy including an application logic as the highest hierarchy level, an abstraction layer as the middle hierarchy level, and at least one specific management program for the used transmission technologies as the lowest hierarchy level, the application logic providing the connection to the tertiary transmission infrastructure, the abstraction layer of the application ensuring the general operating cycle, and the specific management programs for the individual transmission technologies generating the specific communication data. The transmission technologies can expediently include different communication protocols or communication technologies.

The application logic can expediently include the assignment of the individual items of incoming data to the list of the managed network nodes, in particular sensors or consumption meters. The list of the managed network nodes can advantageously include an entry for the transmission technologies used in each case. It is hence easily possible to coordinate the functions of the different transmission technologies.

It is advantageously possible that the application logic includes monitoring the data transport according to the data type and the associated transport guidelines. The application logic can expediently include performing prioritizations and implementing mechanisms for repeating transmissions in the tertiary communication path. In addition, the application logic can include managing operational information, protocols and diagnostic data. The application logic can expediently include monitoring security information and security procedures.

In addition, the abstraction layer can advantageously include performing prioritizations and implementing mechanisms for repeating transmissions in the primary communication path. The abstraction layer can expediently include performing the transmit organization for the individual transmission technologies and transceivers.

In addition, it is particularly expedient that the specific management programs include mapping the information from the bottom level of the transmission frame for the purpose of data-type abstraction.

The gateway can thus advantageously include software for handling the transmission technology used by the at least one network node. The handling of the transmission technologies can include the network key management for LoRaWAN and MIOTY, and also the symbol rate for wired M-bus, or different addressings, in particular for IEEE EUI64 and M-bus addresses (primary and secondary). In addition, the software can perform the timing for bidirectional communication with a network node, in particular a sensor or a consumption meter.

Interoperation is thereby guaranteed. This includes the abstraction of the individual uplinks, performing the individual measures for different technologies in the downlink, and also cooperating with individual network services in the backhaul and connecting all individual technical services to a unified interface for the head-end system.

With the objects of the invention in view, there is additionally provided a gateway for communicating over primary communication paths and for communicating over tertiary communication paths, comprising at least one transceiver, gateway software for connecting to a tertiary transmission structure, the gateway software including specific management programs for generating specific communication data for the transmission technologies used in the primary communication path. The at least one transceiver is expediently set up for communication via an LPWAN protocol. The communication over a tertiary communication path can take place advantageously via a shared infrastructure. At least one transceiver can preferably be provided for the communication via the shared tertiary infrastructure.

With the objects of the invention in view, there is further provided a shared-usage tertiary infrastructure for communicating over tertiary communication paths with at least one head-end system and with a gateway, wherein specific network services are performed for the transmission technologies used in the primary communication path. The specific network services can include a plurality of technology-specific services, in particular services specific to LoRaWAN or services specific to MIOTY. The communication can be performed expediently over a tertiary communication path to the gateway.

With the objects of the invention in view, there is concomitantly provided a method for applying the program logic of the gateway software, which program logic is executed according to the invention.

Other features which are considered as characteristic for the invention are set forth in the appended claims.

Although the invention is illustrated and described herein as embodied in an arrangement and a method for operating a network infrastructure, a method for operating a gateway, a gateway, a shared-usage tertiary infrastructure and a method for applying a program logic of gateway software, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a highly simplified schematic block diagram of an arrangement of a network infrastructure;

FIG. 2 is a highly simplified schematic block diagram of an arrangement of a network infrastructure using three different transmission technologies;

FIG. 3 is a highly simplified schematic block diagram of an arrangement of a network infrastructure having a network node using two different transmission technologies; and

FIG. 4 is a highly simplified schematic block diagram of gateway software.

### DETAILED DESCRIPTION OF THE INVENTION

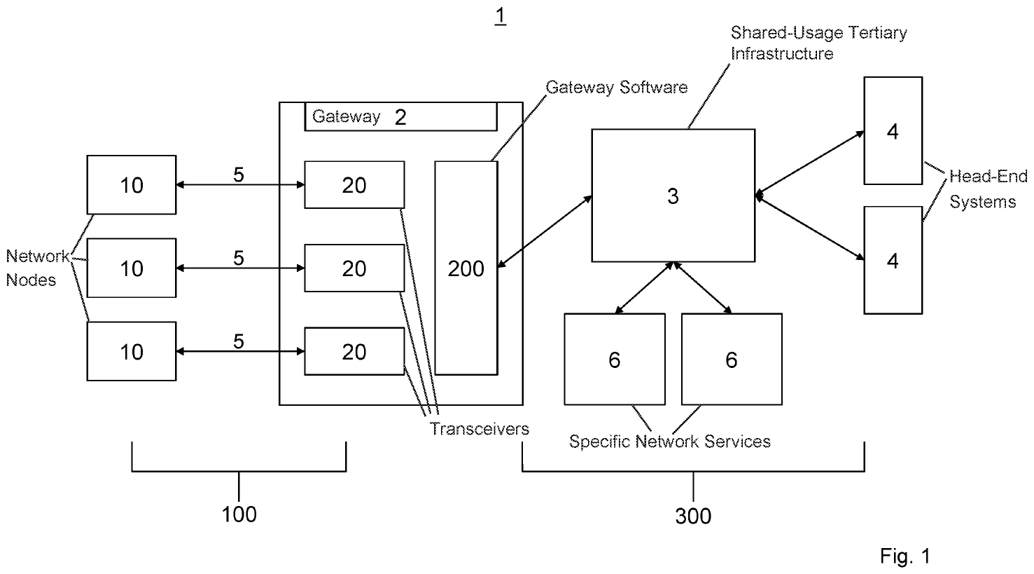

Referring now to the figures of the drawings in detail and first, particularly, to FIG. 1 thereof, there is seen an arrangement of a network infrastructure 1. This arrangement includes three network nodes 10 and a gateway 2, which gateway is equipped with three transceivers 20. The network nodes 10 communicate with the gateway 2 over primary communication paths 100, and the transceivers 20 are configured in such a way that they can communicate via transmission technologies 5 used by the network nodes 10.

The network infrastructure 1 also includes two head-end systems 4, to which data from the network nodes 10 is routed. The data is transmitted from the gateway 2 to the head-end systems 4 over tertiary communication paths 300. A shared-usage tertiary infrastructure 3 for the tertiary communication paths 300, is provided in the network infrastructure 1 according to the invention. The tertiary infrastructure 3 is connected for this purpose between the gateway 2 and the head-end systems 4. The tertiary infrastructure 3 can thereby provide central network services. FIG. 1 shows two specific network services 6. These network services 6 make available specific services for the transmission technologies 5 used in the primary communication path 100. Thus, the tertiary infrastructure 3 is part of the backhaul and hence forms the interface to the individual specific network services 6.

The gateway 2 also includes gateway software 200, which guarantees the processing of the data arriving through the network nodes 10, so that the data is available for shared usage in the tertiary infrastructure 3.

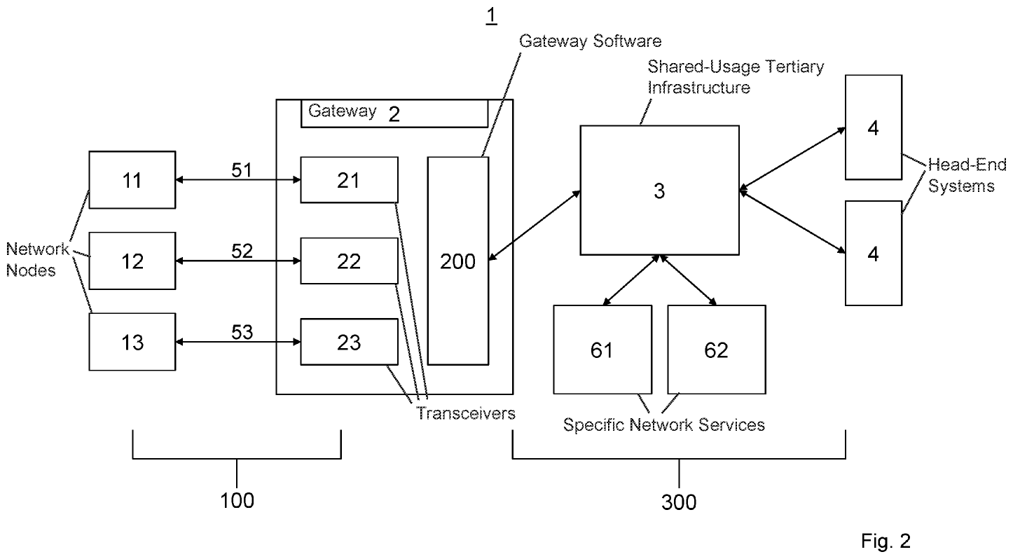

FIG. 2 shows an alternative embodiment of the network infrastructure 1. This alternative embodiment includes three network nodes 11, 12, 13 and a gateway 2 having three transceivers 21, 22, 23. Each network node 11, 12, 13 uses a different transmission technology 51, 52, 53 as the primary transmission path 100 between the network nodes 11, 12, 13 and the gateway 2. Each transceiver 21, 22, 23 is configured to communicate by one of the three transmission technologies 51, 52, 53. For example, the first transmission technology 51 can be LoRaWAN, the second transmission technology 52 can be MIOTY, and the third transmission technology 53 can be wireless M-bus. The network nodes 11, 12, 13 are accordingly a LoRa network node 11, a MIOTY network node 12 and a wM-bus network node 13. Specific network services 61, 62 for the different transmission technologies 51, 52 are provided in the shared-usage tertiary infrastructure 3. For example, the specific network services 61, 62 can include providing keys for the network, for instance in the form of a LoRaWAN join server as the first specific network service 61 and a MIOTY service center as the second specific network service 62.

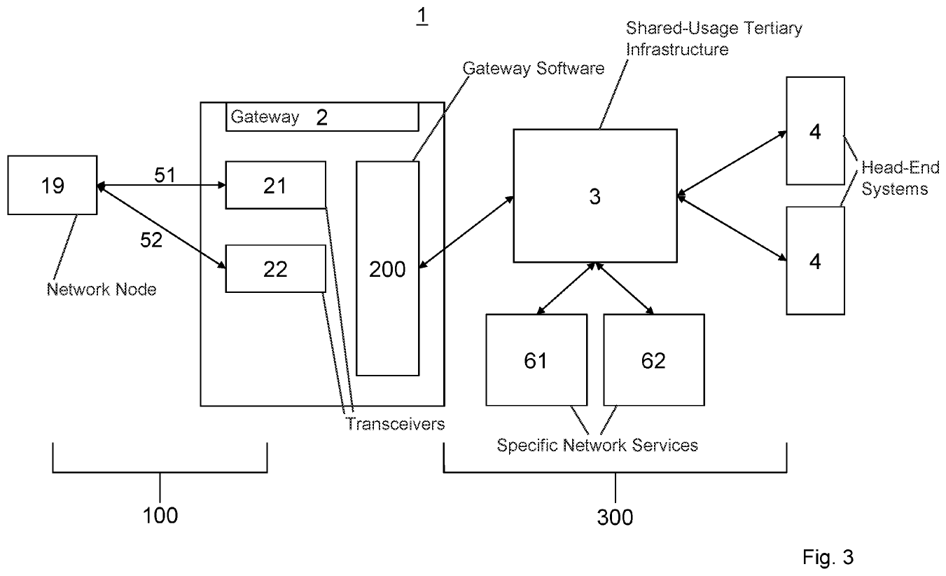

FIG. 3 shows an embodiment of the network infrastructure 1, which includes a network node 19 that has two different transmission technologies 51, 52. The gateway 2 includes two transceivers 21, 22, each of which is configured to communicate via one of the two transmission technologies 51, 52. In this case, the network node 19 communicates with the first transceiver 21 via the first transmission technology 51 and with the second transceiver 22 via the second transmission technology 52. In the tertiary communication path 300, the shared-usage tertiary infrastructure 3 provides specific network services 61, 62. The tertiary infrastructure 3 makes available to the network node 19 first specific network services 61 for the first transmission technology 51, and second specific network services 62 for the second transmission technology 52. It is hence possible in the backhaul to simultaneously access services 61, 62 of the network node 19 that are specific to the transmission technologies 51, 52. Different network services 61, 62 can thereby be combined within one network infrastructure 1.

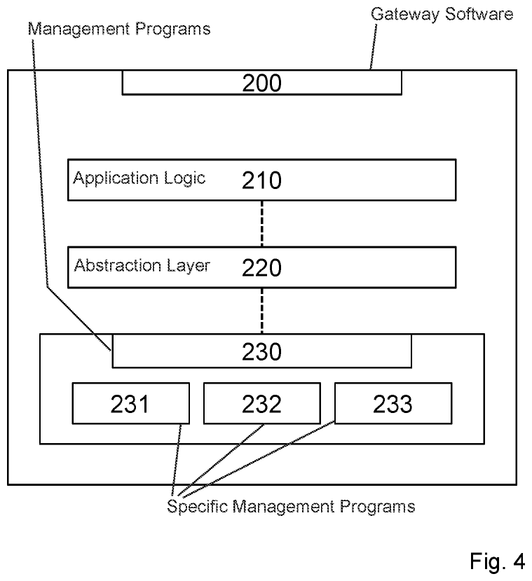

FIG. 4 shows a highly simplified schematic representation of gateway software 200. The gateway software 200 has a three-level hierarchy. The highest hierarchy level constitutes an application logic 210. The application logic 210 provides the connection to the tertiary transmission infrastructure 300. The application logic 210 assigns, for example, the incoming data to a list of the managed network nodes 10. In addition, the application logic 210 monitors the data transport according to the data type and the associated transmission guidelines. The application logic 210 also performs the prioritization and repeated transmission of data in the tertiary communication path 300. In addition, the application logic 210 manages operational information, protocols and diagnostic data, and monitors the security information and security procedures.

The middle hierarchy level is provided by an abstraction layer 220. The abstraction layer 220 ensures the general operating cycle in the gateway 2. The abstraction layer 220 also performs the prioritization and repeated transmission of data in the primary communication path 100. In addition, the abstraction layer 220 performs the transmit organization for the individual transceivers 20 and corresponding transmission technologies 5.

The lowest hierarchy level is formed by management programs 230. The management programs 230 for the individual transmission technologies 5 generate the communication data specific to the transmission technologies 5. In addition, the management programs 230 map the information from the bottom level of the transmission frame for the purpose of data-type abstraction. FIG. 4 shows by way of example three specific management programs 231, 232, 233. These can be, for example, LoRaWAN handlers, MIOTY handlers or wM-bus handlers.

The following is a summary list of reference numerals and the corresponding structure used in the above description of the invention.

### LIST OF REFERENCES

1 network infrastructure

2 gateway

3 tertiary infrastructure

4 head-end system

5 transmission technology

6 network services

61 specific network services

62 specific network services

10 network node

11 network node

12 network node

13 network node

19 network node

20 gateway transceiver

100 primary communication path

200 gateway software

210 application logic

220 abstraction layer

230 management programs

231 specific management program

232 specific management program

300 tertiary communication path

1. An arrangement of a network infrastructure, the arrangement comprising:
a gateway having at least one transceiver;
a primary communication path and tertiary communication paths;
at least one network node using a transmission technology, said at least one network node communicating with said gateway over said primary communication path;
said at least one transceiver configured to communicate by said transmission technology used by said at least one network node;
at least one head-end system, said gateway communicating with said at least one head end system over said tertiary communication paths;
a shared-usage tertiary infrastructure intended for said tertiary communication paths, said shared-usage tertiary infrastructure intended to provide central network services; and
said shared-usage tertiary infrastructure providing specific network services for said transmission technologies in said primary communication path.

2. The arrangement according to claim 1, wherein said at least one network node is at least one of a sensor, a consumption meter or an end device.

3. The arrangement according to claim 1, wherein said gateway includes software for handling said transmission technology used by said at least one network node.

4. The arrangement according to claim 1, wherein said at least one network node uses a technology from a low-power wide area network class as said transmission technology, and said specific network services of said tertiary infrastructure provide corresponding specific network services of the LPWAN protocols.

5. The arrangement according to claim 1, wherein:
said at least one network node includes at least first and second network nodes using respective first and second transmission technologies;
said at least one transceiver of said gateway includes at least first and second transceivers, said first transceiver configured to communicate by said first transmission technology used by said first network node, and said second transceiver configured to communicate by said second transmission technology used by said second network node; and
said shared-usage tertiary infrastructure provides first specific network services for said first transmission technology, and second specific network services for said second transmission technology.

6. The arrangement according to claim 1, wherein said transmission technologies in said primary communication path include wired technologies and non-wired technologies using radio transmission.

7. The arrangement according to claim 1, wherein:
said at least one transceiver of said gateway includes at least first and second transceivers;
said at least one network node has at least first and second transmission technologies, causing said at least one network node to communicate with said first transceiver via said first transmission technology, and causing said at least one network node to communicate with said second transceiver via said second transmission technology;
said shared-usage tertiary infrastructure providing said at least one network node with first specific network services for said first transmission technology, and second specific network services for said second transmission technology.

8. A method for operating a network infrastructure, the method comprising:
providing said at least one network node, said gateway, said at least one head-end system and said shared-usage tertiary infrastructure according to claim 1; and
using said shared-usage tertiary infrastructure to cause said gateway to receive data messages from said at least one network node, to check an identity of a sender, to determine a data type, and to transmit data to said intended head-end system.

9. The method according to claim 8, which further comprises the gateway additionally collects the incoming data selectively, detects the connection properties, and performs data operations, in particular data reduction and data sorting, with the transmission to the intended head-end system being carried out in accordance with stipulated data guidelines.

10. The method according to claim 8, which further comprises using said shared-usage tertiary infrastructure to arbitrate a transmission between linked network devices and network services, permitting data transmissions to be routed from senders to intended recipients, with mutual trust being warranted.

11. The method according to claim 10, which further comprises providing the mutual trust by using certificates.

12. The method according to claim 8, which further comprises using said shared-usage tertiary infrastructure to provide said specific network services for said transmission technologies for device integration and providing keys for a network.

13. The method according to claim 8, which further comprises using said shared-usage tertiary infrastructure to guarantee said tertiary communication paths, said tertiary infrastructure being intended to provide central network services.

14. The method according to claim 13, which further comprises providing a LoRa join server or MIOTY service center as said central network services, for integration defined in a standard or for key allocation procedures.

15. A method for operating a gateway, the method comprising:
providing the arrangement of a network infrastructure according to claim 1;
providing gateway software with a three-level hierarchy including an application logic as a highest hierarchy level, an abstraction layer as a middle hierarchy level, and at least one specific management program for said transmission technologies as a lowest hierarchy level;
using said application logic to provide a connection to said tertiary transmission infrastructure;
using said abstraction layer to ensure an application of a general operating cycle; and
using said at least one specific management program individually for transmission technologies to generate specific communication data.

16. The method according to claim 15, which further comprises using said application logic for an assignment of individual items of incoming data to a list of said managed network nodes or sensors or consumption meters.

17. The method according to claim 15, which further comprises using said application logic for monitoring data transport according to data type and associated transport guidelines.

18. The method according to claim 15, which further comprises using said application logic for performing prioritizations and implementing mechanisms for repeating transmissions in said tertiary communication path.

19. The method according to claim 15, which further comprises using said application logic for managing operational information, protocols and diagnostic data.

20. The method according to claim 15, which further comprises using said application logic for monitoring security information and security procedures.

21. The method according to claim 15, which further comprises using said abstraction layer for performing prioritizations and implementing mechanisms for repeating transmissions in said primary communication path.

22. The method according to claim 15, which further comprises using said abstraction layer for performing a transmit organization individually for said transmission technologies and for transceivers.

23. The method according to claim 15, which further comprises using said at least one specific management programs for mapping information from a bottom level of a transmission frame for data-type abstraction.

24. A gateway for communicating over primary communication paths and for communicating over tertiary communication paths, the gateway comprising:
at least one transceiver; and
gateway software for connecting to a tertiary transmission structure, said gateway software including specific management programs for generating specific communication data for transmission technologies used in the primary communication path.

25. A shared-usage tertiary infrastructure for communicating over tertiary communication paths with at least one head-end system and with a gateway, the shared-usage tertiary infrastructure comprising:
specific network services being performed for said transmission technologies used in said primary communication path according to claim 8.

26. A method for applying a program logic of gateway software, the method comprising executing a program logic according to claim 15.
